(19) United States
(12) Patent Application Publication
(10) Pub. No.: US 2004/0246557 A1
(43) Pub. Date: Dec. 9, 2004

(54) Integrated optoelectronic device comprising an electroabsorption modulator and an electronic element for controlling the modulator

(75) Inventors: Rene Lefevre, Marly Le Roy (FR); Pascal Pecci, Chilly-Mazarin (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/855,332

(22) Filed: May 28, 2004

(30) Foreign Application Priority Data
Jun. 3, 2003 (FR) 03 06 662

(51) Int. Cl. G02F 1/03; G02F 1/07

(52) U.S. Cl. 359/241

(57) ABSTRACT

The present invention relates to an integrated optoelectronic device (100) comprising an electroabsorption modulator (10) suitable for delivering an output modulated optical signal (S_{f}) carrying data, and an electronic control element (20) suitable for driving said modulator. The modulator (10) comprises a plurality of modulation sections (11, 12, 13) that are optically coupled together, each having a respective electrode (1, 2, 3), each of said modulation sections being suitable for receiving an optical signal delivered by the adjacent modulation section disposed upstream in the light propagation direction (Z). The electronic control element (20) comprises distributed electrical amplifier means (22, 23, 24) suitable for delivering to each of said modulation sections an amplified modulated electrical “control” signal (V1, V2, V3), and an electrical propagation line (21) for said control signals which is provided with a plurality of segments, some of which are “electrode” segments corresponding to said electrodes (1, 2, 3).

The invention relates to the field of transmitting data at a high rate on optical fibers, and it relates more particularly to an integrated optoelectronic device comprising an electroabsorption modulator suitable for delivering an output modulated optical signal carrying data, and an electronic control element suitable for controlling said modulator.

In known manner, in order to fabricate sources of modulated optical signals carrying data, e.g. emitting at a wavelength of 1.55 micrometers (μm), it is possible to use a continuous laser followed by an external modulator such as electroabsorption modulator (EAM) controlled by a voltage source implemented with a transistor, for example.

In order to operate at a high data rate, a large amount of research is presently being undertaken in particular for the purpose of integrating the control transistor and the external modulator which need to be matched to each other.

Furthermore, there are two types of electroabsorption modulator in existence: distinct modulators and traveling wave modulators.

The cutoff frequency of discrete modulators is given by the following relationship:

f_{c}=1/(2π(R_{S}+R_{L})Cₘ)

where:

R_{S} is the series resistance of the modulator;

R_{L}≈50 ohms (Ω) is the impedance of the control source; and

Cₘ is the capacitance of the modulator.

At present, a discrete modulator operates properly at 40 gigahertz (GHz) with a length of about 100 μm, capacitance Cₘ of about 70 fentofarads (fF), and a series resistance R_{S} of about 5Ω.

The cutoff frequency increases with shortening length of the electrode. To operate at a high rate, e.g. at 80 gigabits per second (Gbit/s) or 160 Gbit/s, it is therefore necessary to shorten this length drastically, for given intrinsic zone thickness and waveguide width. Nevertheless, shortening length also reduces optical effectiveness as represented by a low extinction ratio, and requires control voltages that are very high, since the optical/electrical interaction distance is no longer sufficient.

A traveling wave electroabsorption modulator (TWEAM) is characterized by having a distributed electrode such that two kinds of propagation take place: propagation of the guided light; and propagation of an electrical wave. While they are co-propagating, modulation energy is transferred from the electrical signal to the optical signal. It is deemed that this dual propagation exists when the propagation time is not negligible compared with the rise time of a bit, in other words when the length of the distributed electrode is not negligible relative to the wavelengths of the various components of the modulation signal.

Traveling wave electroabsorption modulators are made of technology based on lithium niobate, or more recently, like discrete modulators, out of technology based on III-V semiconductor materials of the InGaAsP type. These semiconductor materials present a control voltage and thus a power consumption that is small, and the resulting modulators are less bulky.

By distributing capacitance along a propagation line, traveling wave modulators make it possible in theory to overcome the problem of a limitation on the electrical passband.

Nevertheless, electrical wave losses during propagation along the electrode are high and determine a limiting length for a given passband. In addition, the characteristic impedance of the propagation line of the modulator is generally too low compared with that of the control transistor, which puts a limit on the electrical power transmitted to the modulator. Voltage gain is too small at high frequency.

Both discrete electroabsorption modulators and traveling wave electroabsorption modulators therefore provide poor performance above 40 GHz.

The object of the invention is to provide an integrated optoelectronic device including an electroabsorption modulator that is compact, that consumes little power, that operates at a high rate, and that produces one or more modulated optical signals having satisfactory extinct ratio and optical power.

To this end, the invention provides an integrated optoelectronic device comprising:

an electroabsorption modulator suitable for delivering an output modulated optical signal carrying data; and

an electronic control element suitable for driving said modulator;

the device being characterized in that the modulator comprises a plurality of optically coupled modulation sections each having a respective electrode, each of said modulation sections being suitable for receiving an optical signal delivered by the adjacent modulation section disposed upstream in the light propagation direction; and

in that the electronic control element comprises:

distributed electrical amplifier means suitable for delivering to each of said modulation sections a respective “control” amplified modulated electrical signal; and

an electrical propagation line for said control signals, which line is provided with a plurality of segments, some of which are “electrode” segments and correspond to said electrodes.

There are no constraints on the number of modulation sections, and thus on the total length of the modulator of the invention. The electroabsorption modulator of the invention is distributed and likewise its electrical amplification is distributed: each electroabsorption modulation section contributes to generating a modulated optical signal which, on outlet, presents an extinction ratio (in decibels (dB)) corresponding to the sum of the extinction ratios of the sections.

The electronic control element or “driver” of the invention is selected to be fast and presents high total voltage gain. This element is capable of delivering control signals, e.g. control voltages, of peak-to-peak level that is sufficient and matched for each modulation section.

The distributed electrical amplification means are such that the control signal for the modulation section furthest upstream, which receives the continuous inlet optical signal, is smaller in magnitude than the control signal for the modulation section furthest downstream.

Integrating electrical propagation line segments in the modulation sections reduces the impedance mismatch between the electronic element and the optical modulator, and thus increases transducer gain.

Advantageously, with at least one of said modulation sections receiving a modulated inlet optical signal, some of said segments are phase adjustment means making it possible to act at least in said section to put the control signal into phase with the modulated inlet optical signal so as to avoid interfering with the data.

Preferably, between two adjacent modulation sections it is possible to interpose an optical amplifier, preferably a semiconductor amplifier, so as to compensate for optical losses.

In a preferred embodiment, each of the modulation sections may be a traveling wave section.

The distributed electrical amplifier means may comprise a plurality of transistors having high electron mobility and preferably bipolar heterojunction transistors or high electron mobility field effect transistors (HEMTs). Said transistors are connected in common to another electrical propagation line which is suitable for conveying a modulated electrical signal, e.g. coming from a time multiplexer.

The modulation sections may be in alignment and the electrical propagation line for the control signals may be of crenellated shape, preferably including impedance matching means at its inlet and outlet.

In addition, the impedance of the electrical propagation line for the control signals can thus be adjusted easily and made small, if necessary.

The optoelectronic device may include a source of at least one continuous optical signal placed upstream from said modulator in the light propagation direction, e.g. a laser source, together with an optical waveguide disposed downstream from said modulator in the light propagation direction.

In a first embodiment of the invention, the optoelectronic device is monolithic and preferably made on a substrate based on indium phosphide for good compactness.

In a second embodiment of the invention, the electroabsorption modulator is made on a substrate based on indium phosphide, while the electronic control element is hybrid and is made in part on a distinct substrate based on gallium arsenide or on indium phosphide. Certain segments referred to as “interconnections” are selected from gold tapes, gold wires, and other flexible conductor elements.

The invention naturally applies to any transmission system including an integrated optoelectronic device as defined above.

The features and advantages of the invention appear clearly on reading the following description which is given by way of non-limiting illustrative example and is made with reference to the accompanying drawings, in which:

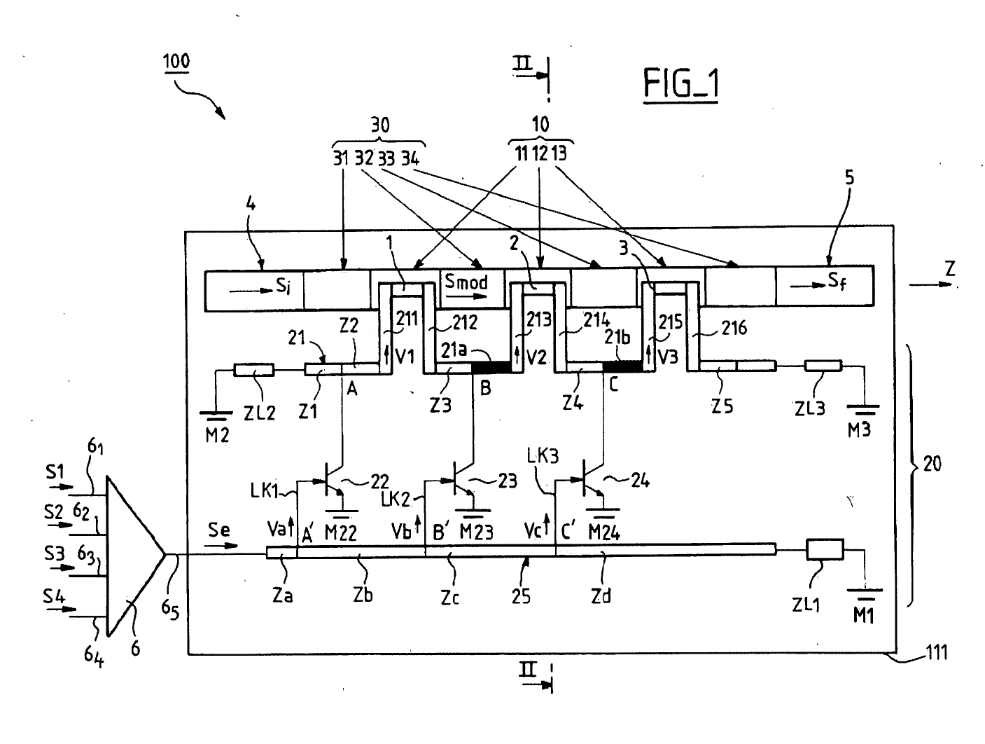

FIG. 1 is a diagrammatic plan view of an integrated optoelectronic device in a preferred embodiment of the invention; and

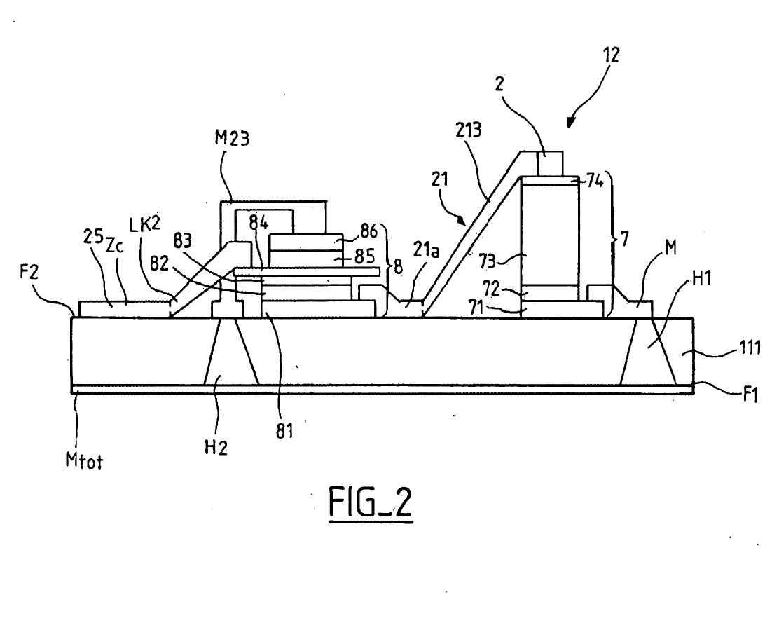

FIG. 2 is a diagrammatic fragmentary side view in section of the integrated optoelectronic device of FIG. 1.

FIG. 1 is a plan view which is not to scale, showing an integrated optoelectronic device 100 in a preferred embodiment of the invention.

The optoelectronic device 100 is an integrated source of at least one high data rate modulated optical signal suitable for insertion in a transmission system (not shown) e.g. containing a transmission optical fiber.

The device 100 is preferably monolithic and is made on a substrate 111 of indium phosphide InP.

The device 100 is designed to operate at a high data rate, e.g. at 160 GHz, i.e. at a modulation wavelength of 300 μm.

The integrated optoelectronic device 100 comprises:

an electroabsorption modulator 10 which comprises, for example, first, second, and third electroabsorption modulated sections 11, 12, and 13 that are optically coupled together and preferably in alignment, and that are traveling wave sections, each having a respective electrode 1, 2, or 3;

an electronic control element 20 for the modulator, referred to as a “driver”, which is made up of an electrical propagation line 21 referred to as a “first” electrical line, a distributed set of electrical amplifier means 22, 23, and 24, and in this example a second electrical line 25;

preferably a continuous source, e.g. a longitudinal and transverse monomode laser 4, e.g. emitting at 1.55 μm or at one of the other wavelengths in the C or L transmission bands, said source 4 being disposed upstream from the modulator 10 relative to the light propagation direction identified by axis Z;

preferably an outlet optical waveguide 5 disposed downstream from the modulator 10 relative to the light propagation direction Z;

preferably a series 30 of four optical amplifiers 31 to 34, preferably semiconductor amplifiers that are about 800 μm long each, and that are interposed respectively between the continuous laser source 4 and the first modulation section 11, between the first and second modulation sections 11 and 12, between the second and third modulation sections 12 and 13, and between the third modulation section 13 and the outlet optical waveguide 5.

In this example, each electrode 1, 2, 3 is distributed and of length which is selected to be less than or equal to 300 μm so as to form a transmission line. The distributed set of electrical amplifier means is constituted by three electrical amplifiers 22, 23, 24, each being constituted by a high electron mobility transistor, e.g. and preferably a bipolar heterojunction transistor. Each emitter is connected to a respective ground M22, M23, M24.

In a variant (not shown), each of the bipolar heterojunction transistors 22 to 24 is followed by a second bipolar heterojunction transistor in a “cascode” connection in order to deliver a control signal of better quality.

Furthermore, the transistors 22 to 24 may also be field effect transistors.

The transistors 22 to 24 have their collectors connected to distinct points A, B, and C of the first electrical line 21 which thus corresponds to an outlet line.

This first electrical line 21 which is substantially crenellated in shape, in particular for making it more compact, comprises a plurality of segments, e.g. sixteen segments, between a line matching input impedance ZL2 connected to ground M2 and a line matching output impedance ZL3 connected to ground M3. These impedances ZL2 and ZL3 may be different from 50Ω.

The first electrical line 21 thus comprises:

five segments referenced by their impedances Z1 to Z5;

six “interconnection” segments 211 to 216, two per modulation section;

two segments 21a, 21b which are means for adjusting electrical phase (drawn in black); and

three electrode segments, i.e. corresponding to the three electrodes 1 to 3.

The impedances are adjusted by selecting their width, e.g. to be equal to 20 μm, and their length, e.g. constituting inductors having inductances of about 100 nanohenries per meter (nH/m).

The bases of the transistors 22 to 24 are also connected via links LK1 to LK3 to distinct points A′, B′, and C′ of the second electrical line 25 which thus corresponds to an inlet line.

The second electrical line 25 is thus subdivided into four segments referenced by their impedances Za to Zd, each being adjusted by selecting its width, preferably equal to 10 μm, and its length. By way of example, the impedances Za to Zd present inductances of about 250 nH/m.

The inlet of this second electrical line 25 is connected to a single outlet branch 65 from an electrical time multiplexer 6 having four inlet branches 6₁ to 6₄, and the outlet of the second electrical line is connected to a low resistance resistor ZL1, e.g. presenting resistance of 50Ω or less, and connected to ground M1.

In operation, four electrical signals S1 to S4 modulated at 40 Gbit/s are interlaced in time by means of the electrical multiplexer 6 which delivers on its output 6₅ a modulated electrical signal Sₑ at 160 Gbit/s, at about 0.5 volts (V), which propagates along the second electrical line 25.

The transistors 22 to 24 are fed with voltages Va, Vb, Vc from the second electrical line 25 and they deliver amplified modulated signals which are control currents that generate control voltages V1, V2, V3 that propagate in the first electrical line 21.

At the inlet of the first modulation section 11, a control voltage V1 is obtained having a peak-to-peak value which is selected to be equal to about 0.5 V.

At the inlet to the second modulation section 12, the control voltage V2 is selected as a function of losses, as is the control voltage V3 at the inlet to the third modulation section 13.

In parallel, a continuous optical signal Sᵢ of power equal to about 1 watt (W), for example, is generated by the laser source 4 and is amplified by the amplifier 31. In the first modulation section 11, this signal Sᵢ is modulated at a rate of 160 Gbit/s by the control voltage V1 applied to the electrode 1. The extinction ratio is about 6 dB.

The modulated optical signal S_{mod} is then amplified by the amplifier 32 and injected into the second modulation section 12. The modulation is reinforced by the control voltage V2 which is in phase with said modulated optical signal because of the segment 21a. The extinction ratio is about 13 dB.

After passing through the amplifiers 33 and 34, and the third modulation section 13, a high data rate modulated signal S_{f} is obtained at the outlet from the waveguide 5 presenting power of at least about 0 dBm and an extinction rate equal to at least 13 dB.

FIG. 2 is a diagrammatic and fragmentary lateral section view on line II, that is not to scale and that shows the integrated optical device 100.

The section is made through the second modulation section 12 by way of example.

The modulation section 12 comprises a vertical structure 7 which is a stack of epitaxial layers made on the “top” face F1 of the substrate 111.

The vertical structure 7 thus comprises:

a bottom layer 71 of p− doped InP connected to a ground plane Mtot beneath the bottom face F2 of the substrate 11 via a ground connection M and a plated-through hole H1 made in the substrate 11;

another layer 72 of p− doped InP;

an active layer 73, e.g. an InGaAsP quantum well layer; and

a contact layer 74 of n− doped InGaAs.

Above this structure there is formed an electrode segment 2, e.g. in the form of a titanium, platinum, and gold multilayer structure having a thickness of 2 μm.

The bipolar transistor 23 is constituted by a stack 8 of the following layers:

a layer 81 of n− doped InGaAs covered in a layer 82 of n+ doped InP covered in a layer 83 of InGaAsP, these three layers forming the collector;

a layer 84 of InGaAsP forming the base, which layer is wider, being deposited at its end on insulating material such as polyimide (not shown); and

a layer 85 of n+ doped InP covered in a layer 86 of n+ doped InGaAs and connected to the ground plane Mtot via a ground connection M23 and a plated-through hole H2 made in the substrate 111, these layers forming the emitter.

The second electrical line 21, e.g. a titanium, platinum, and gold multilayer structure having thickness of 2 μm, is connected via the interconnection segments 213 to the electrode segment 2.

The first electrical line 25, e.g. a titanium, platinum, and gold multilayer structure having thickness of 2 μm, is connected by the link LK2 to the base of the transistor 23.

Thus, in the configuration shown, the link LK2 and the interconnection segments 213, are likewise titanium, platinum, and gold multilayer structures, e.g. formed on an insulating material such as polyimide (not shown).

In a variant (not shown) of this embodiment, the electrical control element 20 is hybrid so as to make it easier to fabricate, and it is made in part on a substrate that is distinct and that is based on gallium arsenide or on gallium or on indium phosphide. The interconnection segments 211 to 216 are then selected from gold-based wires, gold-based tapes, and other flexible conductor elements such as a polyamide tape coated in copper.

The continuous source 4, the electroabsorption modulator 30, the series 30 of four optical amplifiers, and the outlet optical waveguide 5 are fabricated on the indium phosphide InP substrate 111.

Naturally, the above description is given purely by way of illustration. Without going beyond the ambit of the invention, any means could be replaced by equivalent means.

The number of modulation sections may also be greater than two. Their lengths are adjusted as a function of the desired performance.

1. An integrated optoelectronic device (100) comprising:
an electroabsorption modulator (10) suitable for delivering an output modulated optical signal (S_{f}) carrying data; and
an electronic control element (20) suitable for driving said modulator;
the device being characterized in that the modulator (10) comprises a plurality of optically coupled modulation sections (11, 12, 13) each having a respective electrode (1, 2, 3), each of said modulation sections being suitable for receiving an optical signal delivered by the adjacent modulation section disposed upstream in the light propagation direction (Z); and
in that the electronic control element (20) comprises:
distributed electrical amplifier means (22, 23, 24) suitable for delivering to each of said modulation sections a respective “control” amplified modulated electrical signal (V1, V2, V3); and
an electrical propagation line (21) for said control signals, which line is provided with a plurality of segments, some of which are “electrode” segments and correspond to said electrodes (1, 2, 3).

2. An integrated optoelectronic device (100) according to claim 1, characterized in that with at least one of said modulation sections (12, 13) receiving a modulated inlet optical signal (S_{mod}), some of said segments (21a, 21b) are phase adjustment means enabling the phase of the control signal to be matched in at least said modulation section with the phase of said modulated inlet optical signal.

3. An integrated optoelectronic device (100) according to claim 1, characterized in that between two adjacent modulation sections (11, 12, 13) there is interposed an optical amplifier (32, 33).

4. An integrated optoelectronic device (100) according to claim 1, characterized in each of the modulation sections (11, 12, 13) is a traveling wave section.

5. An integrated optoelectronic device (100) according to claim 1, characterized in that the distributed electrical amplifier means (22, 23, 24) comprise a plurality of high electron mobility transistors (22a to 24b), said transistors having their inlets connected to a common other electrical propagation line (25) suitable for conveying a modulated electrical signal (Sₑ).

6. An integrated optoelectronic device (100) according to claim 1, characterized in that the modulation sections (11, 12, 13) are in alignment, and said electrical propagation line (21) is of crenellated shape.

7. An integrated optoelectronic device (100) according to claim 1, characterized in that it includes a source (4) of at least one continuous optical signal disposed upstream from said modulator (10) in the light propagation direction (Z), together with an optical waveguide (5) disposed downstream from said modulator in the light propagation direction.

8. An integrated optoelectronic device (100) according to claim 1, characterized in that it is monolithic.

9. An integrated optoelectronic device (100) according to claim 1, characterized in that the electroabsorption modulator is made on a substrate based on indium phosphide, and in that the electronic control element is hybrid, said element being made in part on a distinct substrate based on gallium arsenide or on indium phosphide, and some of said segments constituting “interconnection” segments being selected from wires based on gold, tapes based on gold, and other flexible conductor elements.

10. A transmission system incorporating the integrated optoelectronic device (100) according to claim 1.
